(19) United States
(12) Patent Application Publication
(10) Pub. No.: US 2020/0158080 A1
(43) Pub. Date: May 21, 2020

(54) ENERGY CONVERSION SYSTEM

(71) Applicant: Nathan Crumb, South Woodslee (CA)

(72) Inventor: Nathan Crumb, South Woodslee (CA)

(21) Appl. No.: 16/195,943

(22) Filed: Nov. 20, 2018

(51) Int. Cl. F03D 5/02; F03D 5/04

(52) U.S. Cl. CPC F03D 5/02; F03D 5/04

(57) ABSTRACT

An energy conversion system is disclosed. The energy conversion system includes: a first set of wheels; a first chain drivingly engaged with wheels of the first set; a plurality of blades rotatably coupled to the first chain, wherein the plurality of blades are arranged in spaced relation to each other along the first chain and wherein each blade is independently rotatable about a respective blade axis; a blade pitch adjuster for causing controlled rotation of one or more of the blades; and a power generator coupled to at least one of the wheels of the first set.

### TECHNICAL FIELD

The present disclosure relates to power generation systems and, in particular, to systems and methods for converting kinetic energy of moving fluids into mechanical or electric power.

### BACKGROUND

The importance of energy from renewable resources, such as wind, waves, and sunlight, has inspired tremendous amount of research and technological development in the renewable energy sector. As specific examples, wind, wave, and hydropower represent power obtained by harnessing the energy produced by the movement of fluids. Various technologies have been employed to exploit these renewable resources to do useful work.

By way of example, wind turbines can convert wind's kinetic energy into electrical energy. In particular, airflows through wind turbines can provide the mechanical power for generating electricity. Conventional wind turbines (e.g. horizontal- or vertical-axis turbines) tend to be very large and, as a result, are generally installed away from major population centers. The electrical energy that is generated by the wind turbines must then be transmitted, at potentially considerable cost and lost energy, to where the energy is needed. Due to their size, commercial wind turbines (and wind farms, more generally) may have negative aesthetic effects on the surrounding landscape and may potentially adversely affect wildlife.

Wind turbines can also pose serious safety concerns. For example, a wind turbine may experience sudden and unpredictable failure modes (e.g. turbine blades falling off, supporting tower collapsing). As the moving parts of a wind turbine are not enclosed, operation of wind turbines may cause accidental injuries to people and wildlife or damage to surrounding areas. The structural design of conventional wind turbines results in a high center of gravity due to the requirement for positioning the power generator associated with the wind turbine above ground. Furthermore, the design of wind turbines may lead to transmission of high vibration frequency to the foundation onto which the wind turbine structure is secured. These structural obstacles have limited the integration of wind turbines onto new or existing structures.

Accordingly, it would be desirable to provide suitably sized wind energy conversion units that can be conveniently distributed and which address some of the common safety issues associated with conventional wind turbines. More generally, it would be advantageous to provide modular energy conversion systems that convert the kinetic energy of fluids to useful output power, in a safe and environment-conscious manner.

### BRIEF DESCRIPTION OF DRAWINGS

Reference will now be made, by way of example, to the accompanying drawings which show example embodiments of the present application and in which:

FIG. 1 is a perspective view of an example energy conversion system in accordance with example embodiments of the present disclosure.

FIG. 2 is a partial side elevational view of the example energy conversion system of FIG. 1.

FIG. 3 is a partial view of a guide track of the example energy conversion system of FIG. 1.

FIG. 4 is a partial side view of the example energy conversion system of FIG. 1.

FIGS. 5A and 5B show variants of the example energy conversion system of FIG. 1.

FIG. 6 is a perspective view of another example energy conversion system in accordance with example embodiments of the present disclosure.

FIG. 7 shows variants of cross-sectional shapes for blades which may be used in the example energy conversion system of FIG. 1.

FIG. 8 shows an example arrangement of multiple energy conversion systems of FIG. 1.

Like reference numerals are used in the drawings to denote like elements and features.

### DETAILED DESCRIPTION OF EXAMPLE EMBODIMENTS

In one aspect, the present disclosure describes an energy conversion system. The energy conversion system includes: a first set of wheels; a first chain drivingly engaged with wheels of the first set; a plurality of blades rotatably coupled to the first chain, wherein the plurality of blades are arranged in spaced relation to each other along the first chain and wherein each blade is independently rotatable about a respective blade axis; a blade pitch adjuster for causing controlled rotation of one or more of the blades; and a power generator coupled to at least one of the wheels of the first set.

In some implementations, the energy conversion system may also include: a second set of wheels, each of the second set of wheels being axially aligned with a respective one of the first set of wheels; a second chain drivingly engaged with wheels of the second set, the second chain being positioned in parallel spaced relation to the first chain, wherein the plurality of blades extend between the first chain and the second chain, each blade having a first end that is coupled to the first chain and an opposite second end that is coupled to the second chain.

In some implementations, the first and second chains may comprise roller chains.

In some implementations, the first and second chains may comprise belts.

In some implementations, the first and second sets of wheels may comprise sprockets.

In some implementations, each blade axis may be parallel to central axes of the wheels of the first set.

In some implementations, the energy conversion system may also include: a first guide track positioned in parallel spaced relation to the first chain; and for each of the plurality of blades, a first track follower member coupled to the blade, wherein the first track follower member is configured to engage and be moved along the first guide track. The first track follower member may be coupled to the blade, for example, to control the pitch of the blade.

In some implementations, the first guide track may include two or more cam track portions, each cam track portion being positioned adjacent to a respective wheel and defining a cam groove for guiding movement of the first track follower member along the cam track portion.

In some implementations, for each cam track portion, a perpendicular distance between the cam track portion and a central axis of the adjacent wheel may vary along the cam track portion.

In some implementations, the first guide track may include a plurality of rail members connecting adjacent ones of the two or more cam track portions.

In some implementations, the energy conversion system may also include: a second guide track positioned in parallel spaced relation to the second chain; and for each of the plurality of blades, a second track follower member coupled to the second end of the blade, wherein the second track follower member is configured to engage and be moved along the second guide track.

In some implementations, the energy conversion system may also include, for each of the plurality of blades: a first carriage coupled to the first end of the blade and the first chain, the first carriage including at least one rotary actuator that is connected to the first end of the blade, wherein the rotary actuator causes rotation of the first end of the blade with respect to the first chain.

In some implementations, the first carriage further may include a controller operatively coupled to the rotary actuator, and wherein the controller is configured to detect a location of the first carriage along the first chain.

In some implementations, the controller may be configured to detect a location of the first carriage with respect to one or more of the wheels of the first set.

In some implementations, the controller may be configured to determine a direction and amount of rotation of the first end of the blade based on a detected location of the first carriage along the first chain.

In some implementations, the energy conversion system may also include, for each wheel of the first set, at least one rigid bar supported in a fixed position relative to the wheel, wherein the at least one rigid bar is positioned to make contact with each of the plurality of blades sequentially as the first chain is driven.

In some implementations, the at least one rigid bar may be shaped for guiding rotational movement of each of the plurality of blades upon contact.

In some implementations, at least one of the plurality of blades may have an airfoil-shape cross-section.

In some implementations, the energy conversion system may also include one or more axles, each axle connecting a wheel of the first set with a corresponding wheel of the second set in axial alignment with each other.

In some implementations, the power generator may comprise an electric power generator.

In another aspect, the present disclosure describes an energy conversion system. The energy conversion system includes a power generating unit that is mounted on a movable base. The base may, for example, comprise a plate that is rotatable about an axis, and the power generating unit may be fixedly mounted on the plate. The power generating unit includes: a first set of wheels; a first chain drivingly engaged with wheels of the first set; a plurality of blades coupled to the first chain, wherein the plurality of blades are arranged in spaced relation to each other along the first chain and wherein each blade is independently rotatable about a respective blade axis; a blade pitch adjuster for causing controlled rotation of one or more of the blades; and a power generator coupled to at least one of the wheels of the first set.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

The present application discloses an energy conversion apparatus, for converting the kinetic energy of fluids to useful mechanical energy. The energy conversion apparatus includes a plurality of blades that travel in a linear motion relative to each other. The blades are attached to a continuous chain or belt having a closed “loop” structure. The motion of a fluid (e.g. wind, water) past the blades imparts a force on the blades which induces motion in the “loop”. The energy harnessed from the fluid by the blades can be captured by connecting a generator (e.g. electric generator for generating electrical power) to the energy conversion apparatus.

The present application also discloses an apparatus for moving a fluid. The apparatus includes a plurality of blades that are attached to a continuous chain or belt. The pitch of each blade may be controlled so that the blades on each side of the chain or belt move the fluid in the same direction. The chain/belt has a closed “loop” structure. A motor may be drivingly coupled to a drive for the chain/belt. The linear movement of the blades with respect to the chain/belt, which is driven by the motor, may have the effect of moving volumes of a fluid, in a manner similar to fan or propeller devices.

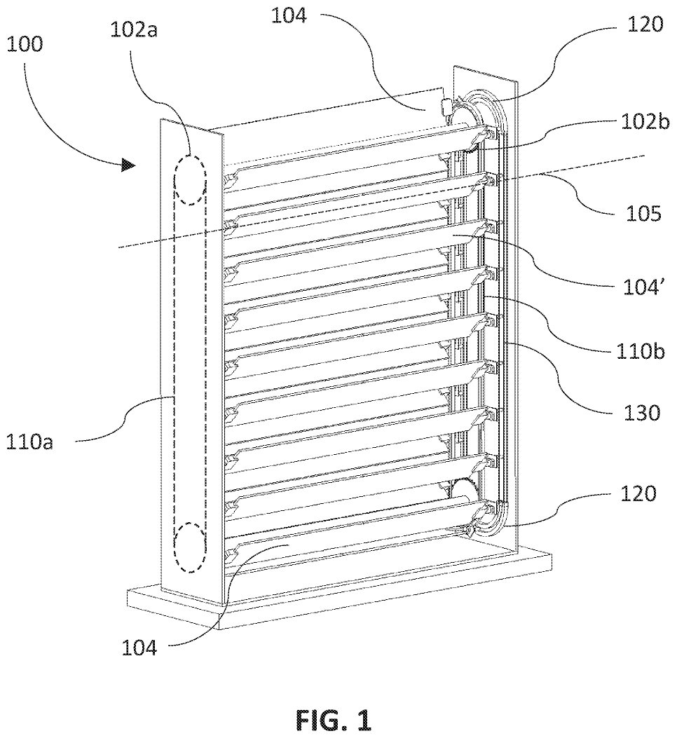

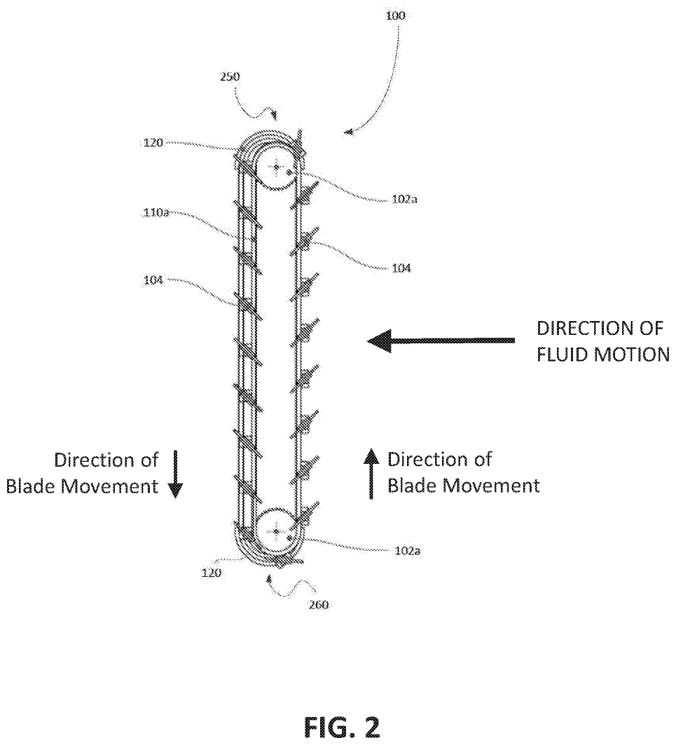

Reference is now made to FIGS. 1 and 2, which show an example energy conversion system 100 in accordance with example embodiments of the present disclosure. The energy conversion system 100 may be used to convert kinetic energy of fluids (e.g. wind, water) into mechanical and/or electrical power. In some embodiments, the energy conversion system 100 comprises a single apparatus having components that together perform a function of converting energy in fluid motion to useful output power. For example, the energy conversion system 100 may be a modular unit device capable of generating power.

The energy conversion system 100 includes a first set of wheels 102a and a second set of wheels 102b. In the energy conversion system 100, the wheels 102a and 102b are arranged such that each of the second set of wheels 102b is axially aligned with a respective one of the first set of wheels 102a. More specifically, each wheel 102a from the first set may be positioned such that its center aligns axially (i.e. lies on same axis) with a center of a corresponding wheel 102b from the second set. In the embodiment shown in FIG. 1, the first set includes two wheels 102a and the second set includes two wheels 102b. The two wheels 102a of the first set are aligned vertically with each other, as are the two wheels 102b. This arrangement of the wheels results in a vertical chain drive structure.

In at least some embodiments, each wheel 102a from the first set and its corresponding wheel 102b from the second set have similar shape and size. That is, pairs of wheels from the first set and the second set may be similarly, or identically, shaped and sized. The energy conversion system 100 may include a plurality of axles or shafts (not shown), where each axle/shaft connects a wheel 102a of the first set with its corresponding wheel 102b from the second set in axial alignment with each other.

The energy conversion system 100 also includes a first chain 110a and a second chain 110b. The first chain 110a is drivingly engaged with wheels 102a of the first set, and the second chain 110b is drivingly engaged with wheels 102b of the second set. As shown in FIG. 1, the second chain 110b is positioned in parallel spaced relation to the first chain 110a. In particular, the wheels 102a of the first set and corresponding wheels 102b of the second set are arranged in spaced relation to each other.

The energy conversion system 100 includes a plurality of blades 104. The blades 104 are rotatably coupled to at least one of the first chain 110a and second chain 110b. In the embodiment of FIG. 1, the blades 104 extend between the chains 110a and 110b. In particular, each blade 104 has a first end that is coupled to the first chain 110a and an opposite second end that is coupled to the second chain 110b. The blades 104 may, for example, extend perpendicularly between the first chain 110a and the second chain 110b. That is, each blade 104 may be arranged such that it is perpendicular to both the first chain 110a and the second chain 110b. In at least some embodiments, the length of a blade 104 (i.e. distance from the first end to the second end) may be smaller than the distance separating the first chain 110a and the second chain 110b. In other words, the blade 104 may not cover the entire perpendicular distance between the first chain 110a and the second chain 110b.

The plurality of blades 104 are arranged in spaced relation to each other along the first chain 110a and the second chain 110b. For each blade 104, the point of connection of the blade on the first chain 110a is separated from the point of connection of an immediately adjacent blade on the first chain 110a (and similarly for the second chain 110b). In some embodiments, the distance between adjacent blades 104 may be uniform along the first and second chains. That is, all, or at least some of the adjacent blades 104 may be separated by the same perpendicular distance.

Each blade 104 is independently rotatable. In particular, each blade 104 may be rotatable about its own respective axis. For example, in at least some embodiments, each blade 104 may be rotatable about a respective blade axis that is parallel to axes passing through pairs of corresponding wheels from the first and second sets. In other words, a blade 104 may be configured to rotate about a respective axis that is substantially perpendicular to both the first chain 110a and the second chain 110b. FIG. 1 shows a blade 104′ extending between the first chain 110a and the second chain 110b. This blade 104′ may be configured to rotate about its respective axis 105.

The independent rotation of the blades 104 allows for control of the relative orientation of each blade 104 with respect to the motion of a fluid. The energy conversion system 100 includes at least one mechanism for controlling the orientation of the blades 104 relative to the blades' direction of motion. More specifically, the energy conversion system 100 includes a blade pitch adjuster for causing controlled rotation of one or more of the blades. The blade pitch adjuster is configured to orient the blades 104 such that a fluid can impart a force in the direction of motion of the blades 104 (which drives motion of the chains 110a and 110b) when the blades 104 come in contact with the moving fluid. That is, a “pitch” of each blade 104, or angle of attack with respect to a moving fluid, may be controllably adjusted. As each blade 104 is located at a different point along the chains, the independent rotation of blades 104 allows for separately controlling the orientation of each blade 104 to facilitate continued linear motion of the blades 104 (and corresponding rotation of the wheels 102a and 102b).

The energy conversion system 100 also includes a power generator (not shown in figures). The power generator is coupled, directly or indirectly, to at least one of the wheels 102a and 102b. For example, the power generator may be operatively coupled to an axle or shaft that is connected to one or more of the sprockets. The conversion of the kinetic energy of a fluid to mechanical energy can be captured by rotational motion of one or more of the wheels. The mechanical energy may then be used to perform useful work, via the generator. For example, the generator may be configured for, among others, electricity generation (i.e. electric power generator), water desalination, or pumping water.

Variants of the above described drive mechanism may be suitable for the energy conversion system of the present disclosure. In at least some embodiments, an energy conversion system may include one set of wheels and a single chain that is drivingly engaged with said wheels. In particular, the energy conversion system may include only one chain drive. A plurality of blades are rotatably coupled to the chain, and each blade is independently rotatable about a respective blade axis. The rotation of the blades about their axes may be controlled by a blade pitch adjustment mechanism. Examples of such mechanisms will be described below.

Various different combinations of components may be used for the chain drive mechanism of energy conversion system 100. For example, the wheels 102a and 102b may be sprockets, gears, drive rollers, or a combination thereof. As another example belt drives (e.g. belt conveyor systems), as opposed to roller chains and sprockets, may be employed. The energy conversion system 100 may additionally or alternatively include one or more pulleys, rollers and wheels, and/or belt tensioners.

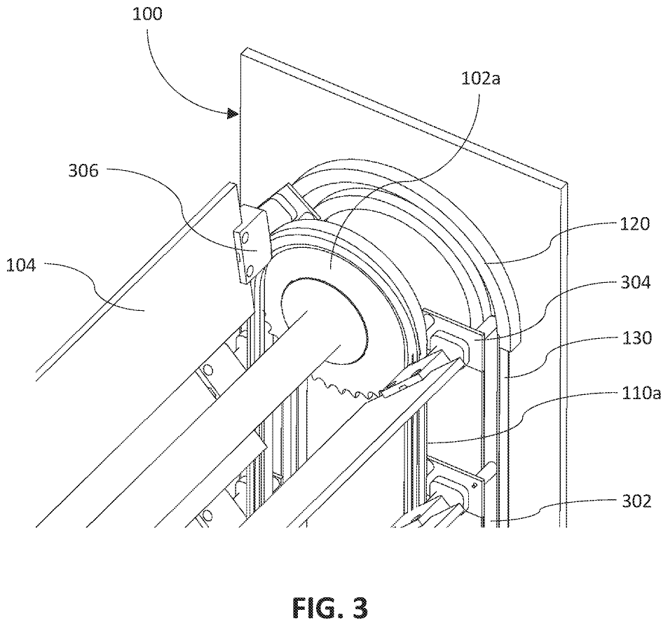

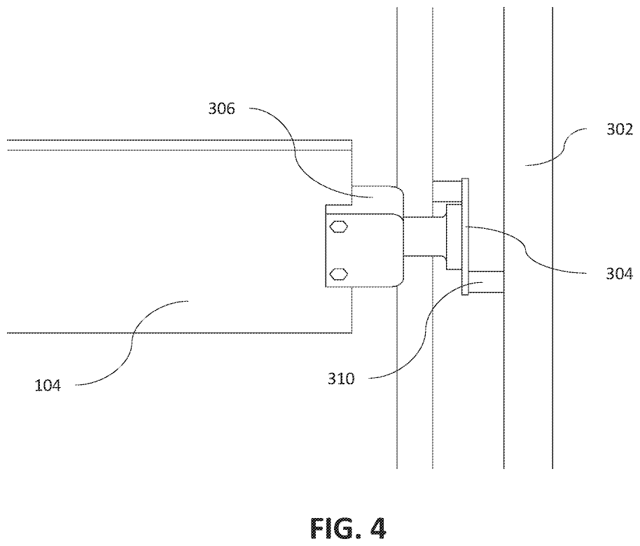

An example mechanism for controlling the orientation of the blades 104 during operation of the energy conversion system 100 is shown in FIGS. 3 and 4. As shown in FIG. 3, the energy conversion system 100 may include a guide track 130. The guide track 130 may be positioned in parallel spaced relation to the first chain 110a. As explained in greater detail below, the guide track 130 may cooperate with the blades 104 and first chain 110a to control the independent rotation of each blade 104 when the blades 104 move linearly along the chains.

In the example of FIG. 3, the blades 104 are coupled to the first chain 110a by means of plates. More specifically, for each of the plurality of blades 104, the energy conversion system 100 may include a first plate 304 affixed to a first end of the blade 104, and a second plate (not shown in FIG. 3) affixed to a second opposite end of the blade 104. The first plate 304 is rotatably coupled to the first chain 110a. Similarly, the second plate is rotatably coupled to the second chain 110b. Supporting the blade 104 at or near both ends may allow the blade 104 to have simpler and more cost effective designs, lower peak forces and stress on and within each blade 104, and simpler blade mounting provisions with which to integrate the blades within the energy conversion system 100.

The energy conversion system 100 of FIG. 3 also includes a guide track 130. Each blade 104 also has a track follower member that is coupled to the blade. In FIG. 3, the track follower member is mounted on a first surface of the first plate 304. The track follower member is configured to engage and be moved along the guide track 130. In particular, a track follower member for a blade 104 moves along a predetermined route defined by the guide track 130. By coupling a track follower member to a first portion of the blade 104, the orientation of the blade 104 with respect to the first chain 110a can be varied as the track follower member (and the corresponding first portion of blade 104) is moved along the guide track 130.

In at least some embodiments, the guide track 130 may include two or more cam track portions 120. Each cam track portion 120 is positioned adjacent to a respective wheel. A cam track portion 120 defines a cam groove for guiding movement of the track follower member along the cam track portion 120. The shape of the cam groove may define the trajectory of the track follower member (and, accordingly, the first plate 304 and blade 104) as the blade 104 is moved linearly along the first chain 110a. That is, as the motion of a fluid imparts a force on the blades 104, the blades 104 may be guided along a trajectory defined, at least in part, by the cam track portion 120.

As shown in FIG. 2, the energy conversion system 100 may include two cam track portions 120 that are positioned adjacent to wheels 102a and 102b. In particular, each cam track portion 120 is positioned adjacent to a respective wheel of the energy conversion system 100. As a blade 104 is moved along from one side of the first chain 110a, past a wheel, to the other side of the first chain 110a, changing the orientation of the blade 104 may facilitate amplifying the net torque that is applied to an output shaft coupled to the wheel as a result of the pushing force of a fluid on the blades 104 on both sides of the chain 110a, and reducing the impeding effects of those blades that are moved in a direction opposite to the direction of motion of the fluid by the driving motion of the first chain 110a.

The positions of the cam track portions 120 enable adjusting the orientation of the blades 104 by causing controlled rotation of the blades 104 when they are located close to a wheel of the energy conversion system 100. For example, as blades 104 are pushed by the force of a moving fluid toward the cam track portions 120 of the guide track 130, the cam grooves may define a guided rotation that each of the blades 104 undergoes as the blade 104 is moved along the cam track portions 120. As another example, for each cam track portion 120, a perpendicular distance between the cam track portion and a central axis of the adjacent wheel may vary along the cam track portion 120. This may allow a distance between a cam track follower and the wheel adjacent to the cam track portion to vary as the blade moves past the wheel along the chain.

More generally, the cam track portions 120 may allow each blade to rotate about a respective blade axis, resulting in a change in orientation (i.e. pitch) of the blade with respect to the first chain 110a (or blade pitch), when the blade “turns a corner”, i.e. moves from one side of a wheel toward the other side of the wheel along the first chain 110a.

The orientation of a blade 104 may be such that fluid (e.g. wind, water) that is incident on the blade 104 on one side of a wheel exerts a force in a first direction while the fluid that is incident on the blades on the other side either exerts a force in the other direction or does not exert a force on the blades. For example, a fluid may exert a force on a blade on a wind-entry side of a wheel in a first direction (e.g. down) but may exert a force on the blade on a wind-exit side of the wheel, after the blade has “turned the corner”, in a second direction (e.g. up) different from the first direction. This allows the blades 104 to work together to drive the chain in a direction of motion. For example, the blades may be rotated such that a blade having a first edge that is an upper edge on one side of a wheel is rotated such that this first edge becomes a lower edge after rotation. Alternatively, a blade may be rotated so that it is generally horizontal or generally parallel to a prevailing wind direction on one side of a wheel while it is angled on the other side. When a blade is on a first side of a wheel, it may be oriented to receive the force exerted by a fluid at a first side and when it is on the opposite side of the wheel, it may be oriented to receive the force of the fluid at a second opposite side.

In some embodiments, the energy conversion system 100 may be positioned such that fluid motion is substantially perpendicular to a direction of travel of the blades 104. The orientation of the blades 104 with respect to the fluid motion is important for ensuring that the incident force on the blades 104 drive movement of the blades along the chains 110a and 110b. The energy conversion system 100 may, in some cases, include louver plates that are positioned adjacent to the chains 110a and 110b such that fluid can be directed toward the blades 104 and chains 110a and 110b.

The guide track 130 may also include a plurality of rail members 302. The rail members 302 may connect adjacent ones of the two or more cam track portions 120. In particular, the guide track 130, comprising cam track portions 120 and rail members 302, may be a continuous track forming a closed, or at least partially closed, loop. The rail members 302 facilitate maintaining an orientation of a blade as the blade moves along the first chain 110a. That is, the orientation of a blade may be held fixed as the cam track follower coupled to the blade traverses the rail members section of the guide track 130.

The energy conversion system 100 of FIG. 3 includes a connecting member 306 for connecting the first end of the blade 104 to a second surface (which is opposite to the first surface) of the first plate 304. In at least some embodiments, the connecting member 306 may comprise a clamp that is affixed to the second surface of the first plate 304. As illustrated in FIG. 4, the clamp may be used to fixedly secure the first end of the blade 104 to the first plate 304.

In the energy conversion system 100 of FIG. 3, the first plate 304 is coupled to the first chain 110a and also engages the guide track 130. The motion of a fluid imparts a force on the blade 104, driving movement of the blade 104 and the first plate 304. In order for the blade 104 to be able to rotate while traversing the cam track portion 120, the first plate 304 is rotatably coupled to the first chain 110a. For example, as in FIG. 3, a screw 310 (or a different fastening component) may be affixed to the first plate 304, such that the screw is rotatably threaded through a roller of the first chain 110a. In this way, the first plate 304 may be capable of controllably rotating with respect to the first chain 110a.

FIGS. 3 and 4 show a single guide track 130 positioned adjacent to the first chain 110a. In practice, a second guide track may also be provided, for guiding movement of a second opposite end of each blade 104. The second guide track may further facilitate controlling the orientation of blade 104 with respect to the movement of a fluid as the blades 104 are moved along the roller chains. Similar to the guide track 130, the second guide track may be positioned in parallel spaced relation to the second chain 110b. A second track follower member may be mounted on a first surface of the second plate, where the second track follower member is configured to engage and be moved along the second guide track.

Other mechanisms for controlling the orientation/pitch of blades 104 during operation of the energy conversion system 100 may be available.

In at least some embodiments, the energy conversion system 100 may include, for each of the plurality of blades 104, a carriage coupled to the first end of the blade 104 and the first chain 110a. The carriage may include at least one rotary actuator that is connected to the first end of the blade 104, where the rotary actuator causes rotation of the first end of the blade 104 with respect to the first chain 110a. That is, at least one mechanical actuator may be provided for each blade 104. For example, the carriage may have an electrically, pneumatically, and/or hydraulically powered actuator to controllably adjust the orientation of the blades 104.

In such a system, the carriage may further include a controller that is operatively coupled to the rotary actuator. The controller may comprise or be coupled to one or more processors. The controller may, in some embodiments, be configured to detect a location of the carriage along the first chain 110a. For example, the controller may be configured to detect (e.g. via use of proximity detection sensors or other types of sensors) a location of the carriage with respect to one or more sprockets 102a of the first set. Additionally, the controller may be configured to determine a direction and amount of rotation of the first end of the blade 104 based on a detected location of the carriage along the first chain 110a.

Such a carriage-based system for controlling orientation of the blades 104 may include a second carriage and associated controller to coordinate rotation of the second end of the blade 104 with respect to the second chain 110b.

The energy conversion system 100 may employ yet another mechanism for controlling orientation of the blades 104 during its operation. More specifically, the energy conversion system 100 may include, for each sprocket 102a of the first set, at least one rigid bar supported in a fixed position relative to the sprocket. The at least one rigid bar is positioned to make contact with each of the plurality of blades sequentially as the first chain 110a is driven. For example, the at least one rigid bar may comprise a stationary peg or block that could be fixed in position with respect to the energy conversion system 100 to physically alter the orientation of each blade 104 upon contact. In some embodiments, the at least one rigid bar may be shaped for guiding rotational movement of each of the plurality of blades when the blade makes contact with the bar. As explained above, the polar ends 250 and 260 are suitable locations for positioning the at least one rigid bar, such that rotation of the blades 104 occurs proximate to the polar ends 250 and 260.

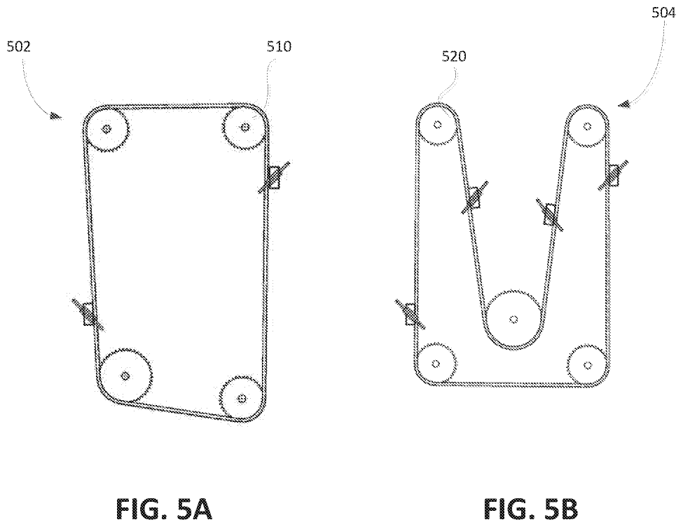

Reference is now made to FIGS. 5A and 5B, which show variants of a chain drive mechanism for the example energy conversion system 100 of FIG. 1. The first variant system 502 includes four sprockets 510 in each set of sprockets, two blades 512, and at least one chain 514 that is drivingly engaged with the sprockets 510. The second variant system 504 includes five sprockets 520 in each set of sprockets, four blades 522, and at least one roller chain 524. The orientation of the blades 512 and 522 are controllably adjusted by suitably rotating the blades to be oriented to receive the force imparted by motion of a fluid. Each sprocket in the variant systems may have an associated cam track portion (such as cam track portion 120 of FIG. 3) to cause change in orientation of blades as they pass by the sprocket. That is, the energy conversion system 100 may include equal numbers of wheels/sprockets as cam track portions, in order to allow for adjusting of blade pitch as blades move along the chains (due to fluid motion or motor-driven chain movement).

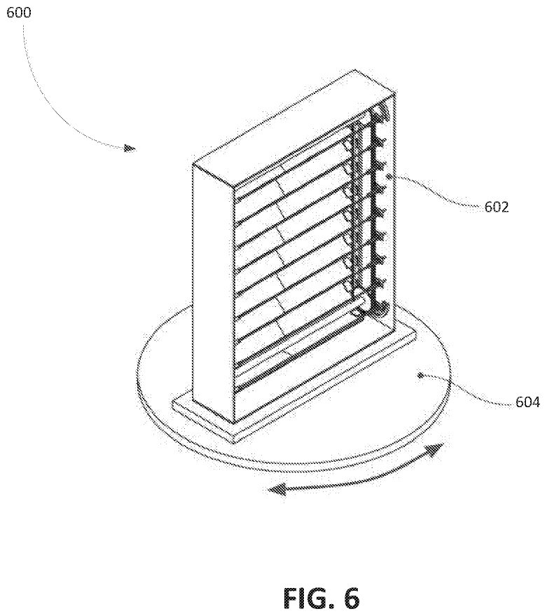

Reference is now made to FIG. 6, which shows another example energy conversion system 600 in accordance with example embodiments of the present disclosure. The energy conversion system 600 includes a base 604 which may be movable (e.g. rotation, translation, etc.) and a power generating unit 602 that is movably mounted on the base 604. In at least some embodiments, the power generating unit 602 may be rotatably mounted on the base 604. The power generating unit 602 may include a housing which contains, in an enclosed manner, an energy conversion apparatus such as system 100 of FIG. 1. Such enclosed design may reduce the risk of accidental injury to humans and animals, while increasing reliability by protecting the various components of the system 100 from exposure to the elements.

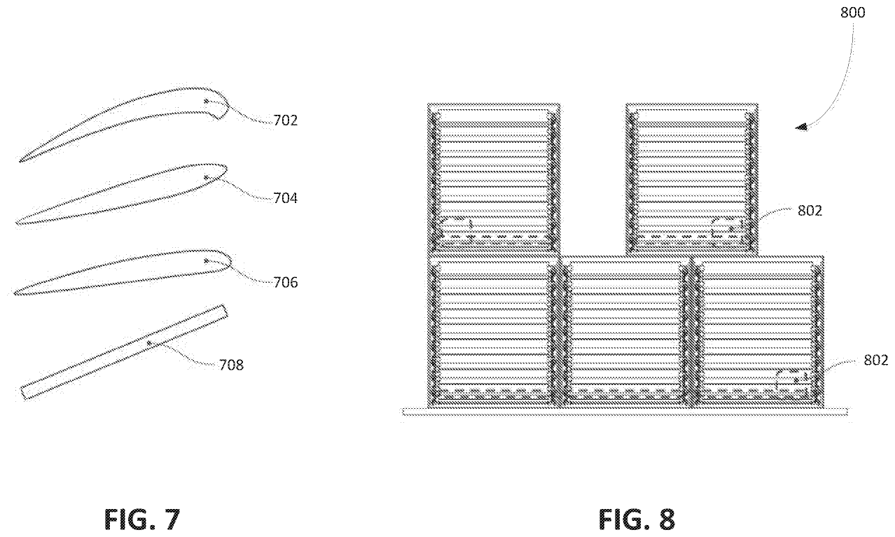

Reference is now made to FIG. 7, which show variants of cross-sectional shapes for blades which may be used in the example energy conversion system of FIG. 1. A blade 104 may have, for example, an airfoil- (702, 704, 706), rectangular (708), trapezoidal, spiral- or elliptical shape cross-section. In some embodiments, a blade 104 may not have a uniform cross-section. A single energy conversion system may employ one or more differential cross-section designs of blades.

Reference is now made to FIG. 8, which shows an example arrangement 800 of multiple energy conversion systems 802. Each energy conversion system 802 may, for example, be a modular unit, which can be arranged in a specific relative location with respect to one or more other energy conversion systems 802. An arrangement 800 may be adjusted in order to take advantage of the direction and magnitude of the motion of a fluid.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. An energy conversion system, comprising:
a first set of wheels;
a first chain drivingly engaged with wheels of the first set;
a plurality of blades rotatably coupled to the first chain, wherein the plurality of blades are arranged in spaced relation to each other along the first chain and wherein each blade is independently rotatable about a respective blade axis;
a blade pitch adjuster for causing controlled rotation of one or more of the blades; and
a power generator coupled to at least one of the wheels of the first set.

2. The energy conversion system of claim 1, further comprising:
a second set of wheels, each of the second set of wheels being axially aligned with a respective one of the first set of wheels;
a second chain drivingly engaged with wheels of the second set, the second chain being positioned in parallel spaced relation to the first chain;
wherein the plurality of blades extend between the first chain and the second chain, each blade having a first end that is coupled to the first chain and an opposite second end that is coupled to the second chain.

3. The energy conversion system of claim 2, wherein the first and second chains comprise roller chains.

4. The energy conversion system of claim 2, wherein the first and second sets of wheels comprise sprockets.

5. The energy conversion system of claim 1, wherein each blade axis is parallel to central axes of the wheels of the first set.

6. The energy conversion system of claim 2, further comprising:
a first guide track positioned in parallel spaced relation to the first chain; and
for each of the plurality of blades, a first track follower member coupled to the blade, wherein the first track follower member is configured to engage and be moved along the first guide track.

7. The energy conversion system of claim 6, wherein the first guide track includes two or more cam track portions, each cam track portion being positioned adjacent to a respective wheel and defining a cam groove for guiding movement of the first track follower member along the cam track portion.

8. The energy conversion system of claim 7, wherein, for each cam track portion, a perpendicular distance between the cam track portion and a central axis of the adjacent wheel varies along the cam track portion.

9. The energy conversion system of claim 7, wherein the first guide track includes a plurality of rail members connecting adjacent ones of the two or more cam track portions.

10. The energy conversion system of claim 6, further comprising:
a second guide track positioned in parallel spaced relation to the second chain; and
for each of the plurality of blades, a second track follower member coupled to the second end of the blade, wherein the second track follower member is configured to engage and be moved along the second guide track.

11. The energy conversion system of claim 1, further comprising, for each of the plurality of blades:
a first carriage coupled to the first end of the blade and the first chain, the first carriage including at least one rotary actuator that is connected to the first end of the blade,
wherein the rotary actuator causes rotation of the first end of the blade with respect to the first chain.

12. The energy conversion system of claim 11, wherein the first carriage further includes a controller operatively coupled to the rotary actuator, and wherein the controller is configured to detect a location of the first carriage along the first chain.

13. The energy conversion system of claim 12, wherein the controller is configured to detect a location of the first carriage with respect to one or more of the wheels of the first set.

14. The energy conversion system of claim 12, wherein the controller is configured to determine a direction and amount of rotation of the first end of the blade based on a detected location of the first carriage along the first chain.

15. The energy conversion system of claim 1, further comprising, for each wheel of the first set,
at least one rigid bar supported in a fixed position relative to the wheel, wherein the at least one rigid bar is positioned to make contact with each of the plurality of blades sequentially as the first chain is driven.

16. The energy conversion system of claim 15, wherein the at least one rigid bar is shaped for guiding rotational movement of each of the plurality of blades upon contact.

17. The energy conversion system of claim 1, wherein at least one of the plurality of blades has an airfoil-shape cross-section.

18. The energy conversion system of claim 1, further comprising one or more axles, each axle connecting a wheel of the first set with a corresponding wheel of the second set in axial alignment with each other.

19. The energy conversion system of claim 1, wherein the power generator comprises an electric power generator.

20. An energy conversion system, comprising:
a base; and
a power generating unit movably mounted on the base, the power generating unit including:
a first set of wheels;
a first chain drivingly engaged with wheels of the first set;
a plurality of blades coupled to the first chain, wherein the plurality of blades are arranged in spaced relation to each other along the first chain and wherein each blade is independently rotatable about a respective blade axis;
a blade pitch adjuster for causing controlled rotation of one or more of the blades; and
a power generator coupled to at least one of the wheels of the first set.
